(19) United States
(12) Patent Application Publication
(10) Pub. No.: US 2010/0215547 A1
(43) Pub. Date: Aug. 26, 2010

(54) CHEMICAL VAPOR SENSOR WITH IMPROVED AGING AND TEMPERATURE CHARACTERISTICS

(75) Inventor: Patrick Dolan, Seattle, WA (US)

Correspondence Address: FSP LLC, P.O. BOX 890, VANCOUVER, WA, 98666, US

(73) Assignee: Patrick Dolan, Seattle, WA (US)

(21) Appl. No.: 12/707,765

(22) Filed: Feb. 18, 2010

Related U.S. Application Data
(60) Provisional application No. 61/208,184, filed on Feb. 23, 2009.

(51) Int. Cl. G01N 27/00; G01N 30/00; B32B 37/00; B32B 15/02

(52) U.S. Cl. 422/88; 422/98; 156/219; 428/546

(57) ABSTRACT

A chemical vapor sensor includes an polymer layer and a first stratum of electrically conductive particles partially embedded in the polymer layer. A second stratum of electrically conductive particles adheres to the first stratum of particles primarily through particle-to-particle attractive forces.

### PRIORITY CLAIM

This application claims priority under 35 USC 119 to USA application no. 61/208,184 filed on Feb. 23, 2009, which is incorporated herein by reference in its entirety.

### TECHNICAL FIELD

The present disclosure relates to chemical vapor sensors.

### BACKGROUND

The water heater industry has adopted certain safety measures for gas fired water heaters to avoid accidental ignition of vapors from flammable household substances spilled in the vicinity of a gas fired water heater. In the case of direct vent and power-vent water heaters, flammable vapor sensors are used to signal the water heater to shut down in the event the vapor sensor detects the presence of a potentially flammable mixture of air and vapor.

These vapor sensors are composed of polymers into which has been mixed a substantial amount of electrically conductive particles, usually carbon black, so as to make the mixture electrically conductive due to physical contact between the particles throughout the polymer-particle mixture.

The polymer-particle mixture is made into a thin layer and allowed to cure during which time cross-linking between polymer chains occurs. When this type of sensor is exposed to flammable solvent or gasoline vapor, molecules of the vapor are absorbed by the polymer which then swells to the point where the carbon particles begin to separate from each other. This separation inhibits the flow of electrons through the sensor and results in an increase in electrical resistance as measured across the sensor. See U.S. Pat. No. 2,930,015 and U.S. Pat. No. 7,138,090 for examples of sensors that span this technology.

One design issue presented by the use of this type of flammable vapor sensor is that the strength of its sensing output signal for a given concentration of sensed flammable vapor tends to diminish over time as the sensor ages. Sensor aging occurs because the polymer does not fully cure at the time of manufacture. The polymer continues to form cross-links long after the sensor has been installed in the water heater. U.S. Pat. No. 7,242,310 teaches a method to compensate for the diminished response of the sensor to flammable vapor due to aging.

The water heater industry specifies that flammable vapor sensors be operable to at least 125 F. The type of gas sensor taught in U.S. Pat. No. 3,045,198 has a response to temperatures near 125 F that is on the same order of magnitude as its response to 50% of the lower flammability limit of gasoline vapor, making it less reliable for use as a water heater safety sensor at higher temperatures.

There is an ongoing need for a chemical vapor sensor that has little or no diminished response due to aging, and with an improved relative response to vapor vs. temperature near 125 F.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1-6 are illustrations of embodiments of a novel chemical vapor sensor.

FIG. 7-9 are scanning electron microscope images of an embodiment of a novel chemical vapor sensor.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

Herein, “approximately” as applied to ranges means that substantially more than half of the described elements fall within the range, although of course in any composition some (e.g. a low percentage, for example but not exclusively less than 10%-20%) of the elements may fall outside the range due to inherent limitations in design precision, manufacturing, filtering, separation, etc. The amounts that one skilled in the art would understand to “approximately” fall within or outside a range may depend upon the precision of the materials employed, the cost, the source of the materials, the manufacturing process, and many other factors.

A sensor may be formed to include an electrically resistive element having a first conductive lead and a second conductive lead. The resistive element may include a non resilient substrate, an elastomeric material, and a stratum layer of electrically conductive particles adhered to and at least partially covering the elastomeric material. A first portion of the conductive layer is electrically coupled with the first conductive lead. The second conductive lead is electrically coupled with a second portion of the conductive layer physically apart from the first portion.

Such a sensor may rapidly determine the change in an environment from one containing a relatively low, or no, concentration of flammable gasoline vapor and/or household solvents, to one containing a gasoline vapor concentration above 50% of the lower flammability limit. The sensor may include an electrically resistive element having a body, a first conductive lead, and a second conductive lead. It may further include a non-resilient substratum, an elastomeric material composed essentially of 100% silicone, and a stratum layer of palladium particles generally adhered to and at least partially covering the elastomeric material. The palladium particles may generally be less than or equal to 0.55 microns. A first portion of the stratum layer may be electrically coupled with the first conductive lead. A second conductive lead may be electrically coupled with a second portion of the stratum layer physically apart from the first portion.

One manner of constructing such a sensor includes applying a layer of an elastomeric material to a non-resilient substrate; applying an outer stratum of electrically conductive particles to the elastomeric material so that the stratum is substantially bonded thereto; and applying an additional stratum of electrically conductive particles onto the first stratum of electrically conductive particles so that the second stratum adheres to the first only by particle-particle cohesion.

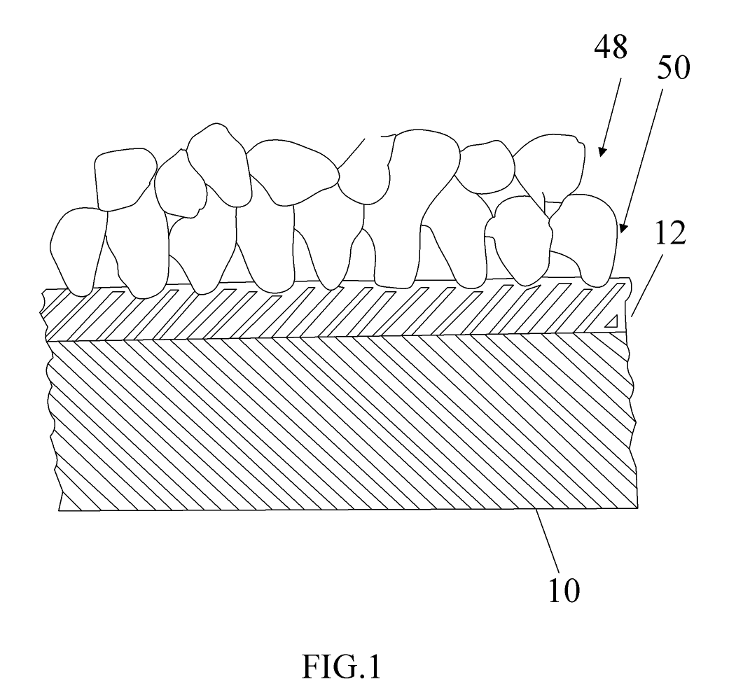

A cross section of a vapor sensor is shown in FIG. 1. The sensor comprises electrically conductive absorbent particles resiliently embedded in a surface and forming an electrical conductive path through the sensor. In the illustrated embodiment, a stratum of electrically conductive particles (50), with substantially each particle in physical contact with its neighboring particles, is anchored to a resilient elastomeric substratum (12) such as Permatex Flowable Silicone Windshield & Glass Sealer, manufactured by Permatex, Inc., Solon, Ohio. The elastomeric material may comprise a siloxane having the formula R2SiO, where R is an alkyl group. The siloxane may be, for example, methoxypolydimethylsiloxane. The elastomeric material may be, for example 100% silicone. Each particle (50) may be independently anchored to the resilient elastomeric substratum (12). The resistance of the electronically conducting path varies in response to the presence of an adsorbate medium exposed to the particles. A first stratum of adsorbent particles of a first size is attached to the surface, extending outwardly from the surface in a position to be exposed to the adsorbate medium, and having a resilient anchoring force against movement beyond a particular magnitude. In one embodiment the first stratum of adsorbent particles have an average and/or median size less than 2 microns in diameter. An additional superstratum of electrically conducting particles (48) is attached by particle-particle cohesive forces to the particles of the stratum (50). Second, adsorbent particles of the same size are interspersed on top of and superior to the first particles and attached to the first particles only by particle-particle cohesive forces. The second particles extend outwardly from the surface in a position to be exposed to the adsorbate medium. They have an anchoring force against movement of magnitudes different than the first higher magnitude. The first and second particles engage one another externally of the surface to form the electrical conducting path. Absorption forces cause the adsorbate to force the particles apart and thus substantially change the resistance of the conductive path. Substantial changes in resistance may not be caused by increases in temperature near 125 F.

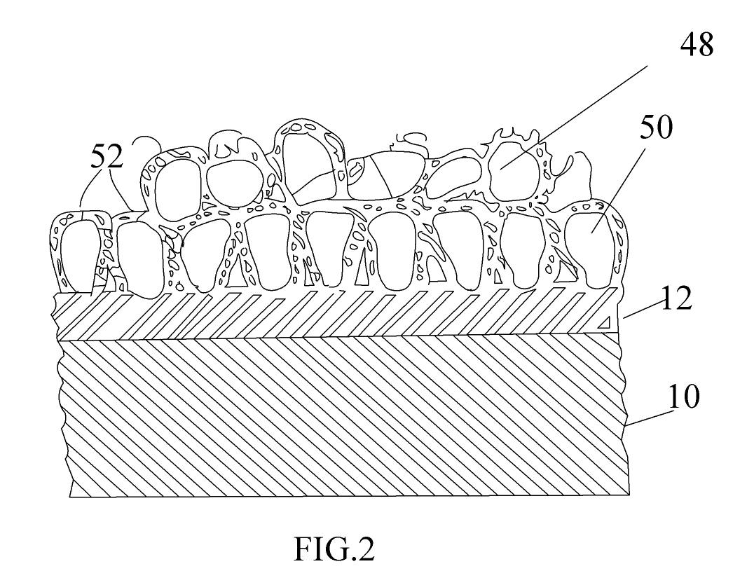

Particle-particle cohesion may be caused by Van Der Waal's attractive forces between particles. The particles (48 and 50) may be palladium and limited to diameters between 0.25 microns and 0.55 microns, of the type supplied by Alfa Aesar of Ward Hill, Mass. The electrically conductive particles may have a maximum size of about 5 microns. The particles comprising the first substratum (50) need not be the same size or material as the particles comprising the second substratum (48). For instance, the first substratum (50) may be comprised of silver particles of diameters between 600 microns and 200 microns while the second substratum (48) may be comprised of palladium particles between 0.25 microns and 0.55 microns. The electrically conductive particles may be composed of one or more members of the group palladium, platinum, platinum black, aluminum, silver, gold, tantalum, iridium, and carbon. The resilient substratum (12) is attached to a non-resilient base material (10). The layer of elastomeric material may be a flowable self-leveling silicone and the stratum of electrically conductive particles may be comprised of palladium particles of diameters between 0.25 microns and 0.55 microns. All the particles taken together form a conductive path. When the sensor is exposed to gasoline vapor, molecules of gasoline adsorb to the surface of the particles to form an electrically insulating layer between each particle, FIG. 2 (52).

Because the particles (48, 50) are not enclosed by the resilient layer (12), further cross-linking of the resilient layer does not cause sensor aging to the same extent in the first layer of particles (50). The second layer of particles (48) has no contact with the resilient layer (12) and therefore is almost completely unaffected by any additional cross-linking of the resilient layer.

Limiting particles (48, 50) to a diameter of less than 5 microns may substantially reduce sensitivity to increasing temperature while maintaining sensitivity to gasoline vapor.

Absorption forces which cause the adsorbate to force the particles apart and thus substantially change the resistance of the conductive path. However, due to numerous interacting properties of the particles and surface, substantial changes in resistance may not be caused by increases in temperature near 125 F. Resilient layer (12) is normally susceptible to significant thermal expansion near 125 F. This expansion causes the particles (48, 50) to separate, resulting in an increase in electrical resistance measured across the sensor, which can be mistaken for the presence of flammable vapor. In one embodiment the resilient layer and particle layers may have a negative radius of curvature less than 0.125″. A substantial reduction may be made in the amount of heat caused resistance by building the resilient layer (12) and the particle layers (48, 50) on a curved surface of negative curvature no greater than 0.125″ radius, preferably on the inside diameter of a hole no greater than 0.25″ in diameter.

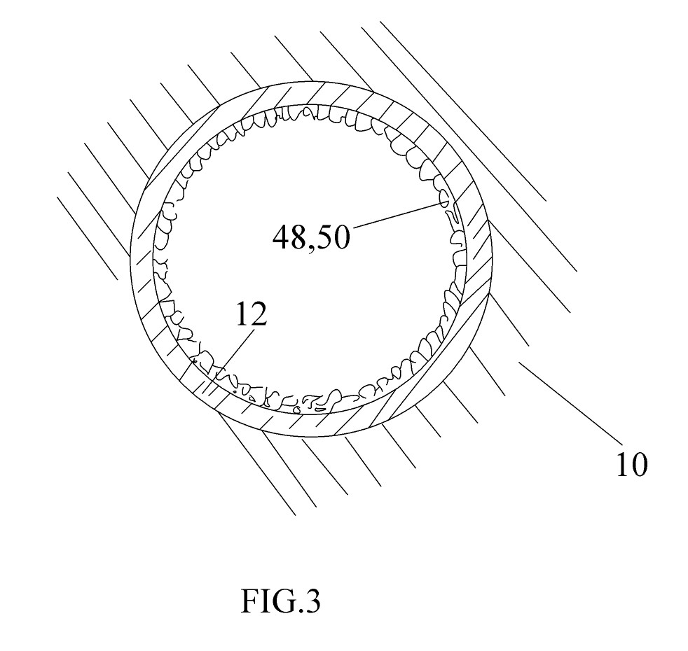

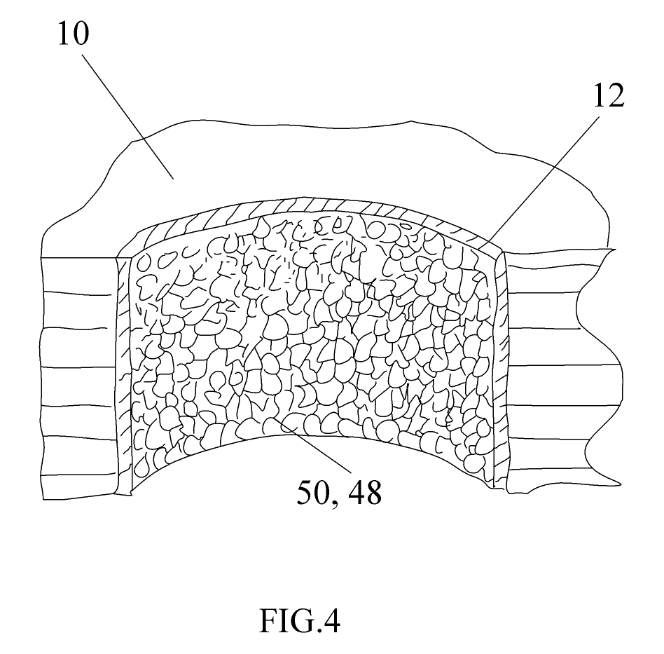

Increasing temperature causes the resilient layer to expand radially inward, thereby compressing the particles (48, 50) closer together which counteracts much of the increase in resistance that would normally occur due to expansion of the resilient layer if the radius of curvature were equal to or greater than zero. See FIG. 3, FIG. 4.

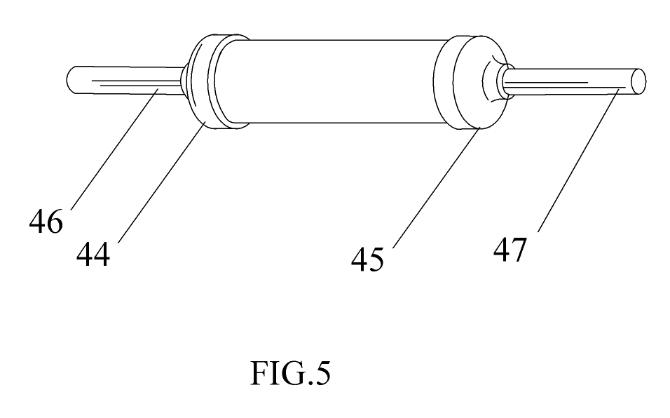

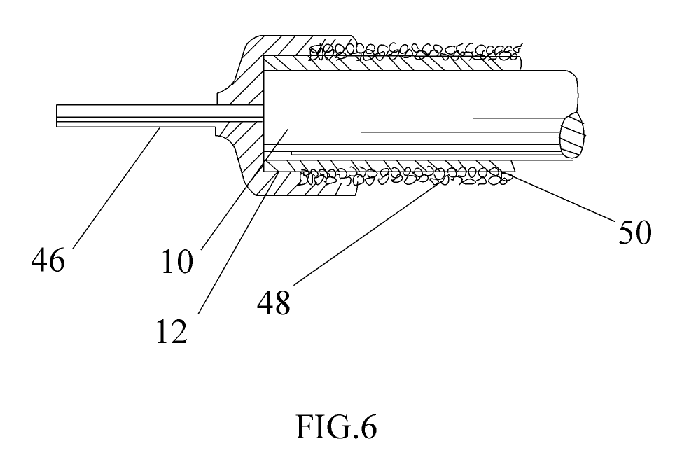

FIGS. 5 and 6 alternatively show a form of vapor sensing element that is cylindrical in shape. The non-conductive cylindrical body (10) is provided with external resilient sleeve (12) to which is applied the first stratum (50) and second stratum (48) of electrically conductive particles. In this embodiment the stratum of particles completely encloses sleeve (12) circumferentially and substantially from end to end. Body (10) comprises conductors (46, 47) extending from opposite ends and conductive connections (44, 45) are provided between the particle stratum (48, 50) and the respective conductors or leads to incorporate the former in a circuit extending between conductors (46, 47). Connectors (48, 49) may be formed of silver print or they may comprise a formed metallic cap electro-conductively disposed between the conductors (46, 47) and the stratum (48,50). Other forms and shapes of a vapor sensing element will be readily visualized without difficulty by those skilled in the art in accordance with the details of the disclosures herein.

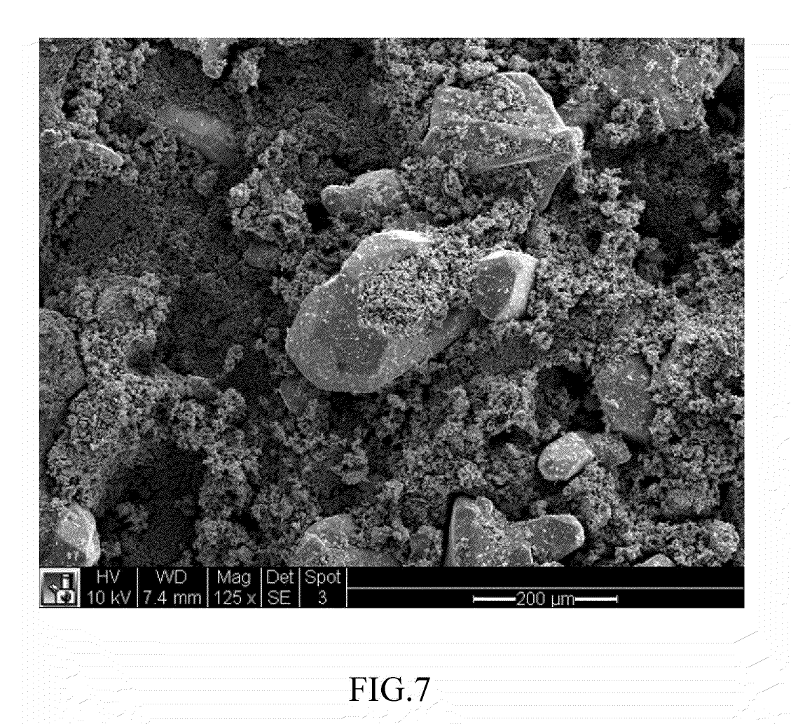

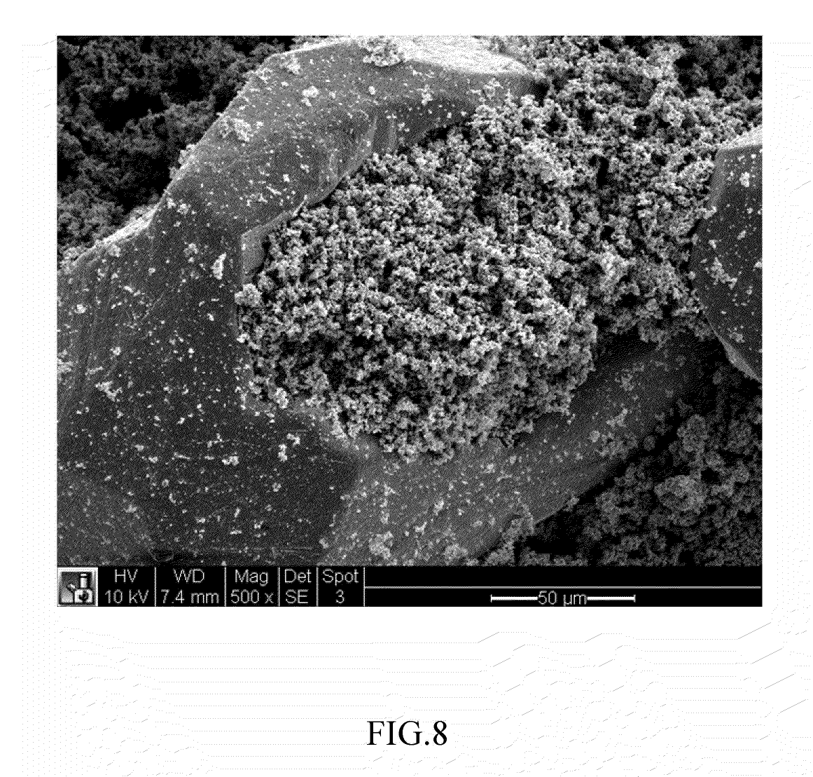

FIG. 7 is a scanning electron microscope image of a vapor sensor embodiment, in which a first substratum of 200-600 micron chemically attached silver particles nearly covered by a second substratum 0.25-0.55 micron palladium particles attached by particle-particle adhesion. As can be seen, the particle-particle adhesion is not only Pd to Ag, but also Pd to Pd. FIG. 8 shows the same material under greater magnification.

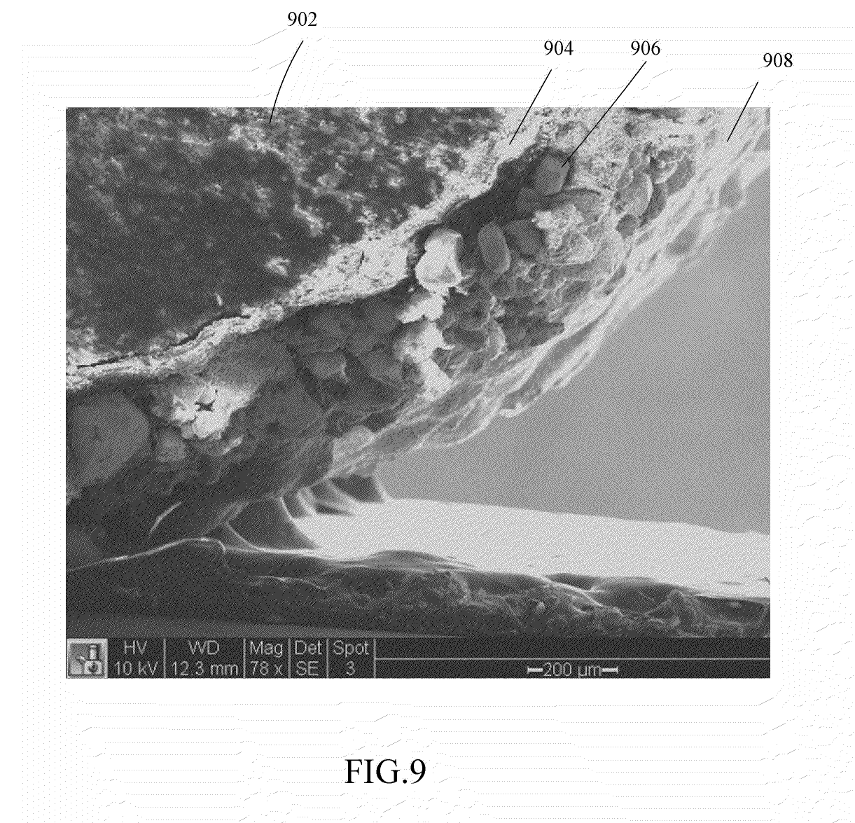

FIG. 9 is a scanning electron microscope image of a vapor sensor embodiment, showing a cross section of an Ag 200-600 micron, Pd 0.25-0.55 micron sensor material. Starting in the upper left and traveling to the lower right, the layers are:

(902) the non-resilient base, which is dark.

(904) the resilient substratum, which is the thin white band.

(906) the chemically bonded 1st substratum of 200-600 micron Ag particles.

(908) the second substratum of 0.25-0.55 micron Pd particles adhering by particle-particle adhesion.

The Pd particles are difficult to see individually at this magnification, and appear as a “powder coat” on the larger Ag particles.

What is claimed is:

1. A chemical vapor sensor comprising:
an elastomeric material layer;
a first stratum of electrically conductive particles bonded chemically to the surface of the elastomeric layer; and
a second stratum of electrically conductive particles adhering to the first stratum of particles primarily through particle-to-particle attractive forces.

2. The chemical vapor sensor of claim 1, wherein the elastomeric material layer further comprises:
substantially 100% silicone.

3. The chemical vapor sensor of claim 1, wherein the first stratum of electrically conductive particles further comprises:
palladium particles.

4. The chemical vapor sensor of claim 1, wherein the first stratum of electrically conductive particles further comprises:
particles less than or equal to 0.55 microns in diameter.

5. The chemical vapor sensor of claim 1, wherein the first stratum of electrically conductive particles bonded chemically to the surface of the elastomeric layer further comprises:
electrically conductive absorbent particles resiliently embedded in the surface of the elastomeric layer.

6. The chemical vapor sensor of claim 1, wherein the elastomeric material further comprises:
a siloxane.

7. The chemical vapor sensor of claim 1, wherein the first stratum of electrically conductive particles further comprises:
particles having an average or median size less than 2 microns in diameter.

8. The chemical vapor sensor of claim 1, wherein the second stratum of electrically conductive particles adhering to the first stratum of particles primarily through particle-to-particle attractive forces further comprises:
particles of a similar size to particles of the first stratum.

9. The chemical vapor sensor of claim 1, wherein the second stratum of electrically conductive particles adhering to the first stratum of particles primarily through particle-to-particle attractive forces further comprises:
particles adhering to the first stratum of particles primarily through Van der Waal forces.

10. The chemical vapor sensor of claim 1, wherein the second stratum of electrically conductive particles adhering to the first stratum of particles primarily through particle-to-particle attractive forces further comprises:
a layer of particles with no contact with the elastomeric layer.

11. The chemical vapor sensor of claim 1, further comprising:
the elastomeric material layer and first and second stratum of particles having a radius of curvature no greater than 0.125 inches.

12. A process of making a chemical vapor detector, comprising:
embedding a first stratum of particles in an elastomeric material layer, such that the first stratum of particles partially protrudes from the elastomeric material layer;
applying a second stratum of electrically conductive particles over the first stratum of particles, the second stratum of particles bonding to the first stratum of particles primarily through particle-to-particle attractive forces; and
installing electrical leads so that an electrical force may be created through the elastomeric material layer, first stratum of particles, and second stratum of particles.

13. The process of claim 12, wherein the second stratum of electrically conductive particles comprises:
particles of a similar size to particles of the first stratum.

14. The process of claim 12, wherein the second stratum of electrically conductive particles further comprises:
particles adhering to the first stratum of particles primarily through Van der Waal forces.

15. A chemical vapor sensor comprising:
an polymer layer;
a first stratum of electrically conductive particles partially embedded in the polymer layer; and
a second stratum of electrically conductive particles adhering to the first stratum of particles primarily through particle-to-particle attractive forces.

16. The chemical vapor sensor of claim 15, further comprising:
the first and second stratum of particles having a similar chemical composition.

17. The chemical vapor sensor of claim 15, further comprising:
the first and second stratum of particles each comprised primarily of one or more of the group of palladium, platinum, platinum black, aluminum, silver, gold, iridium, tantalum, and carbon.

18. A vapor sensor material comprising a resilient substratum, a first layer of silver particles chemically bonded to the resilient substratum, and a second layer of palladium particles adhering to the layer of silver particles by particle-particle adhesion and not chemical bonding.

19. The vapor sensor material of claim 18, further comprising:
the palladium particles also adhering to one another by particle-particle adhesion without chemical bonding.

20. The vapor sensor material of claim 18, the silver particles being approximately 200-600 microns in diameter and the palladium particles being approximately microns 0.25-0.55 in diameter.
